(19) United States
(12) Patent Application Publication
(10) Pub. No.: US 2003/0016899 A1
(43) Pub. Date: Jan. 23, 2003

(54) Optical components with controlled temperature sensitivity

(76) Inventor: Xiantao Yan, Pasadena, CA (US)

Correspondence Address: Travis Dodd, 2490 Heyneman Hollow, Fallbrook, CA, 92028, US

(21) Appl. No.: 09/884,885

(22) Filed: Jun. 18, 2001

(51) Int. Cl. G02B 6/26

(52) U.S. Cl. 385/13; 385/27; 385/137

(57) ABSTRACT

An optical component system is disclosed. The system includes an optical component having a light transmitting medium positioned over a base. One or more waveguides are defined in the light transmitting medium. The one or more waveguides are associated with a wavelength shift. A warping member is positioned adjacent to the base. The warping member is constructed from a single layer of material that acts in conjunction with the base to warp the optical component so as to reduce the wavelength shift of the one or more waveguides below the wavelength shift that occurs without the warping member being positioned adjacent to the base.

### BACKGROUND

1. Field of the Invention

The invention relates to one or more optical networking components. In particular, the invention relates to optical components having a reduced thermal sensitivity.

2. Background of the Invention

Optical networks often employ optical components that include one or more waveguides formed over a substrate. These optical components are often sensitive to temperature changes. For instance, the waveguide material often has an index of refraction that changes as a result of temperature changes. Further, the optical component often warps in response to temperature changes. This warping places strain on the waveguides that can cause the index of refraction of the waveguide to change. As a result, there are two mechanisms available for temperature changes to affect the index of refraction of the waveguides. These changes in index of refraction can affect how the light signals travel through the waveguides and can accordingly affect the performance of the component.

One approach to reducing the temperature sensitivity of optical components has been to position a bi-metal sheet or plate under the substrate. A typical bi-metal includes two layers of metal with different coefficients of thermal expansion (CTE). The difference in the coefficient of thermal expansion causes the bi-metal to warp in response to temperature changes. The bi-metal is attached to the optical component so that the bi-metal warps in a direction opposite to the direction that the optical component warps. As a result, the warping of the bi-metal and the warping of the optical component counter one another to reduce the strain on the optical component.

The bi-metal can be selected such that the warping of the bi-metal and the warping of the optical component act together to create a net strain that also counters the change in the index of refraction that results directly from the temperature change. As a result, the bi-metal counters the effects of the temperature change on the optical component.

Commercially available bi-metals have an unsatisfactory degree of inconsistency. As a result, the use of bi-metals for bulk fabrication of optical components is often associated with waste. Further, a bi-metal often produces an unacceptably different degree of warping for the same temperature change. Additionally, bi-metals are often non-linear in that the degree of warping per degree temperature is not consistent at different temperatures. The non-linear nature of bi-metals reduces the temperature range over which temperature control is possible.

For the above reasons, there is a need for optical components with reduced thermal sensitivity that do not rely on the use of bi-metals.

### SUMMARY OF THE INVENTION

The invention relates to an optical component system. The system includes an optical component having a light transmitting medium positioned over a base. One or more waveguides are defined in the light transmitting medium. The one or more waveguides are associated with a wavelength shift. A warping member is positioned adjacent to the base. The warping member is constructed from a single layer of material that acts in conjunction with the base to warp the optical component so as to reduce the wavelength shift of the one or more waveguides below the wavelength shift that occurs without the warping member being positioned adjacent to the base.

In some instances, the warping member serves to reduce the wavelength shift of the one or more waveguides by greater than 10% of the wavelength shift of the waveguides that occurs without the warping member positioned adjacent to the base; by greater than 50% of the wavelength shift of the waveguides that occurs without the warping member positioned adjacent to the base; by greater than 80% of the wavelength shift of the waveguides that occurs without the warping member positioned adjacent to the base or by greater than 90% of the wavelength shift of the waveguides that occurs without the warping member positioned adjacent to the base.

Another embodiment of the system includes an optical component having one or more waveguides defined in a light transmitting medium positioned over a base. The one or more waveguides are associated with a wavelength shift and the light transmitting medium is associated with a wavelength shift. A warping member is positioned adjacent to the base. The warping member is configured to warp the optical component so as to reduce the wavelength shift of the one or more waveguides below the wavelength shift of the waveguides that occurs without the warping member being positioned adjacent to the base. In some instances, the light transmitting medium is associated with a wavelength shift of greater than 0.01 nm/° C., 0.02 nm/° C., 0.04 nm/° C., 0.06 nm/° C. or 0.08 nm/° C. In some instances, the light transmitting medium is silicon.

Yet another embodiment of the system includes an optical component having one or more waveguides defined in a light transmitting medium positioned over a base. The component is more flexible along a first axis than along a second axis that crosses the first axis. The first axis and the second axis are parallel to a bottom of the base. A warping member is positioned adjacent to the base and is configured to warp the optical component. The warping member is more flexible along the second axis than along the first axis.

Still another embodiment of the invention includes an optical component having one or more waveguides defined in a light transmitting medium positioned over a base. The base includes one or more regions of weakness configured to enhance the flexibility of the optical component along a length of at least one of the waveguides. A warping member is positioned adjacent to the base. The warping member is configured to warp the optical component such that the wavelength shift of the one or more waveguides is less than the wavelength shift of the waveguides that occurs without the warping member being positioned adjacent to the base.

Another embodiment of the invention relates to an optical component. The optical component includes one or more waveguides defined in a light transmitting medium positioned over a base. The base includes one or more regions of weakness configured to bring the flexibility of the optical component along a first axis closer to the flexibility of the optical component along a second axis than occurs without the one or more regions of weakness. The first axis crosses the second axis and is substantially parallel to a bottom of the base.

The warping member can be constructed from a layer of aluminum. In some instances, the layer of aluminum has a thickness of 300-800 μm. The warping member can be constructed from a layer of copper. In some instances, the layer of copper has a thickness of 200-500 μm. The warping member can be constructed from a layer of epoxy. In some instances, the layer of epoxy has a thickness of 600-1200 mm. The warping member can be constructed from a layer of polymer. In some instances, the layer of polymer has a thickness of 800-2000 μm.

### BRIEF DESCRIPTION OF THE FIGURES

FIG. 1A is a perspective view of a portion of an optical component system having an optical component bonded with a warping member. The illustrated portion of the optical component includes a waveguide.

FIG. 1B is a topview of the portion of the optical component system illustrated in FIG. 1A.

FIG. 1C is a cross section of the optical component system of FIG. 1B taken at the line labeled A.

FIG. 1D illustrates an optical component system where the optical component includes a cladding layer.

FIG. 2 shows a topview of an optical component that is suitable for use with a warping member.

FIG. 3 is a curve illustrating the strain applied to a silicon waveguide on an optical component versus the thickness of a warping member bonded to the optical component.

FIG. 4A is a topview of an optical component system. The optical component is more flexible along a first axis than along a second axis that crosses the first axis.

FIG. 4B is a bottomview of the optical component system shown in FIG. 4A. The warping member includes regions of weakness causing the warping member to be more flexible along the second axis than along the first axis.

FIG. 4C is a sideview of the optical component system shown in FIG. 4A.

FIG. 5A is a bottomview of an optical component system. The warping member includes regions of weakness that each includes a plurality of holes formed in the warping member.

FIG. 5B is a cross sectional view of the optical component system shown in FIG. 5A taken at the line labeled A in FIG. 5A.

FIG. 6 is a bottomview of an optical component system. The warping member is constructed from a plurality of spaced apart sections. The gap between adjacent sections serves as a region of weakness that increases the flexibility of an optical component system along an axis.

### DETAILED DESCRIPTION OF THE PREFERRED EMBODIMENT

The invention relates to optical components. The optical components include a light transmitting medium positioned over a base, one or more waveguides being defined in the light transmitting medium and having an index of refraction. A warping member is positioned adjacent to the base. The warping member is configured to warp so as to place a strain on the waveguides that compensates for changes in index of refraction due to temperature changes. As a result, the temperature sensitivity of the optical component is reduced.

In one embodiment of the invention, the warping member is constructed from a single material. For instance, the warping member can be constructed from aluminum or epoxy instead of a bi-metal. Warping members of a single material have not been employed in conjunction with prior optical components because they were not believed to provide sufficient warping to overcome the effects of temperature changes. However, the inventor has discovered that previous equations used to approximate the warping were incorrect. By correcting these equations, the inventor has found that a single material can provide the desired degree of warping. When bi-metals are employed, the warping results from the interaction of the two metal layers. However, when a single layer is employed, the warping results from the interaction of the warping member and the base. Single materials often have an increased consistency over what is available from bi-metals. For instance, aluminum is commercially available with a highly uniform thickness. Similarly, materials such as epoxies can be formed with a highly uniform thickness. Further, materials such as aluminum and epoxy are very cheap and add little to fabrication costs. Additionally, many of these materials are associated with a high degree of linearity that is not found in metal bilayers.

In one embodiment of the invention, the waveguide is constructed from silicon. Prior optical component systems having bi-metal warping members have typically employed silica waveguides because silica waveguides are much less sensitive to temperature changes than silicon waveguides. For instance, silicon is associated with a wavelength shift of 0.08 nm/° C. while silica is associated with a wavelength shift of 0.01 nm/° C. The increased temperature sensitivity of silicon has discouraged the use of bi-metal warping members with optical components having silicon waveguides. However, the inventor'suse of the corrected equations used to approximate the warping has shown that warping members can also be used in conjunction with silicon waveguides and other waveguides having a wavelength shift greater than the 0.01 nm/° C. (silica).

Optical components are generally asymmetrical in that the optical component is more flexible along a first axis than along a second axis. As a result, the amount of warp induced strain along the first axis is different than the amount of warp induced strain along the second axis. The difference in strain causes different polarity light signals to travel through the light transmitting medium differently. Accordingly, the optical component can cause multiple polarity light signals to separate.

In one embodiment of the invention, the optical component is more flexible along a first axis than along a second axis that crosses the first axis, and the warping member is more flexible along the second axis than along the first axis. When the warping member is bonded to the optical component, the warping member reduces the flexibility of the optical component along the second axis less than along the first axis. As a result, attaching the warping member brings the flexibility of the optical component system along the first axis closer to the flexibility of the optical component along the second axis than is achieved without the warping member. Accordingly, the warping member reduces the difference in the warp induced strain along the first axis and along the second axis and accordingly reduces separation of multi-polarity light signals.

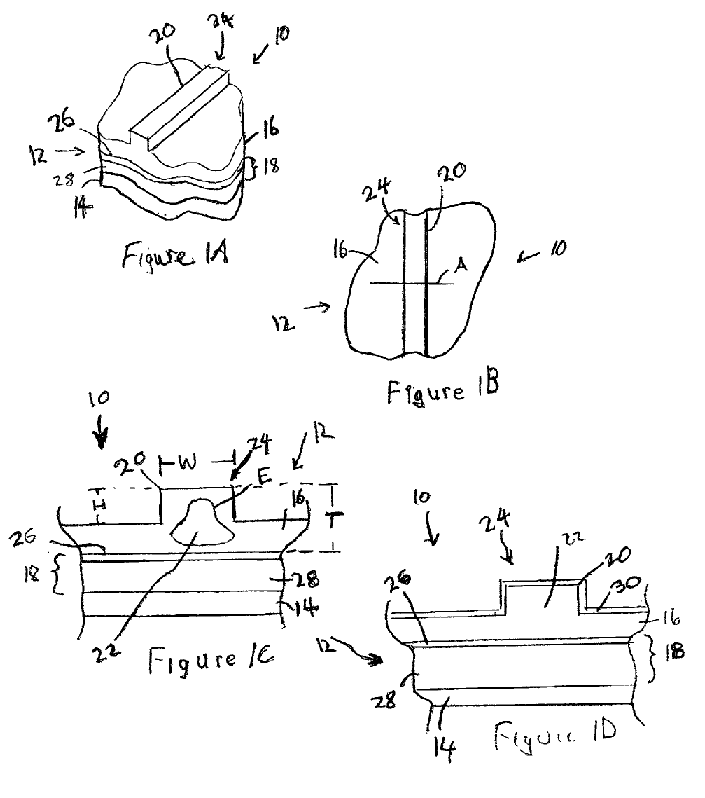

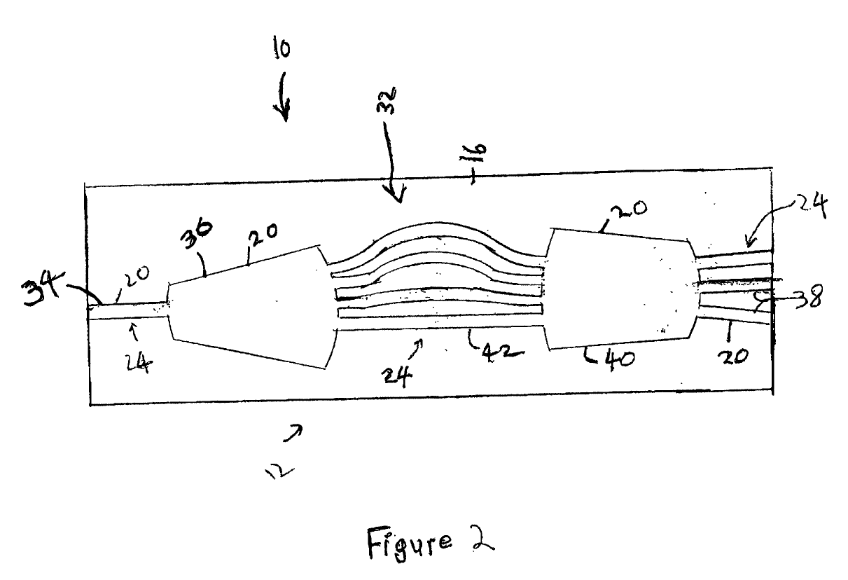

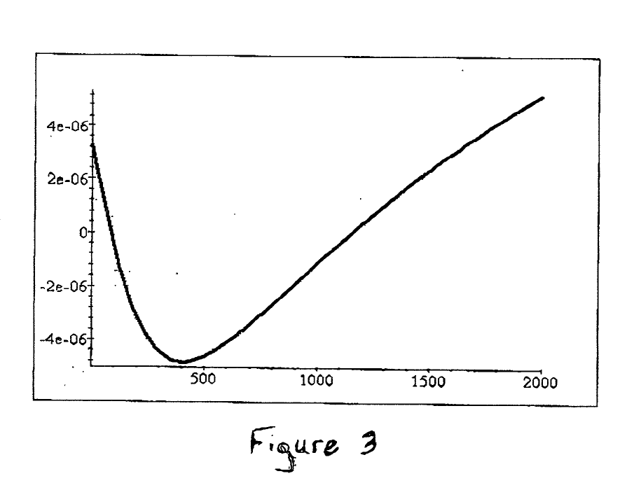

FIG. 1A through FIG. 1C illustrates a suitable construction of an optical component system 10 according to the present invention. FIG. 1A is a perspective view of a portion of an optical component system 10 having an optical component 12 positioned over a warping member 14. FIG. 1B is a topview of an optical component system 10 constructed according to FIG. 1A. FIG. 1C is a cross section of the optical component system 10 in FIG. 1B taken at the line labeled A.

The optical component 12 includes a light transmitting medium 16 positioned over a base 18. The light transmitting medium 16 includes a ridge 20 that defines a portion of the light signal carrying region 22 of a waveguide 24. Suitable light transmitting media include, but are not limited to, silicon, polymers and silica. As illustrated in FIG. 1C, the ridge 20 is characterized by a thickness labeled T, a height labeled H and a width labeled W. A suitable ridge 20 thickness, T, includes, but is not limited to, 4-14 μm and 8-12 μm. A suitable ridge width, W, includes, but is not limited to, a range from 5-10 μm. A suitable ridge 20 height, H, includes, but is not limited to, a range from 3-9 μm.

A variety of base 18 constructions are possible. The illustrated base 18 includes a light barrier 26 positioned over a substrate 28. The light barrier 26 reflects light signals from the light signal carrying region 22 back into the light signal carrying region 22. As a result, the light barrier 26 also defines a portion of the light signal carrying region 22. The line labeled E illustrates the profile of a light signal carried in the light signal carrying region 22 of FIG. 1C.

A cladding layer 30 can be optionally be positioned over the light transmitting medium 16 as shown in FIG. 1D. The cladding layer 30 can have an index of refraction less than the index of refraction of the light transmitting medium 16 so light signals from the light transmitting medium 16 are reflected back into the light transmitting medium 16.

A warping member 14 is positioned adjacent to the base 18. Suitable techniques for bonding the warping member 14 to the base 18 include, but are not limited to, positioning a layer of epoxy between the warping member 14 and the base 18. In some instances, the bonding member is bonded to the base at a temperature within the range of temperatures where temperature control is desired. The warping member 14 can be a single layer of material. For instance, the warping member 14 can be a layer of aluminum, copper, polymer, epoxy, steel, stainless steel and shape memory metals.

The warping member 14 has a different coefficient of thermal expansion (CTE) than the base 18. As a result, the warping member 14 causes the optical component system 10 to warp in response to temperature changes. The resulting warp of the optical component system 10 reduces the temperature sensitivity of the waveguide(s) 24 on the optical component 12.

FIG. 2 shows a topview of an optical component that is suitable for use with a warping member. The optical component includes a demultiplexer having an input waveguide 34 in optical communication with an input star coupler 36 and a plurality of output waveguides 38 in optical communication with an output star coupler 40.

A plurality of array waveguides 42 provide optical communication between the input star coupler 36 and the output star coupler 40. The length of each array waveguide 42 is different and the length differential between adjacent array waveguides, ΔL, is a constant.

During operation of the optical component, light signals from the first waveguide enter the input star coupler 36 that distributes the light signal to a plurality of the array waveguides 42. The light signals travel through the array waveguides 42 into the output star coupler 40. Because the adjacent array waveguides 42 have different lengths, the light signal from each array waveguide 42 enters the output star coupler 40 in a different phase. The phase differential causes the light signal to be focused at a particular one of the output waveguides 38. The output waveguide on which the light signal is focused is a function of the wavelength of light of the light signal. Accordingly, light signals of different wavelengths are focused on different output waveguides 38. As a result, each output waveguide 38 carries a light signal of a different wavelength.

The illustrated optical component 12 is not proportional and the number of waveguides 24 is not necessarily representative. For instance, four array waveguides 42 are shown but demultiplexers 32 often include a different number of array waveguides 42 and can include as many as several tens or hundreds of array waveguides 42. Further, the demultiplexer 32 can include more than three output waveguides 38 although three output waveguides are shown.

Wavelength shift is a commonly used parameter for quantifying the temperature sensitivity of the waveguides 24 on optical components 12 such as the optical component of FIG. 2. As noted above, the index of refraction of the waveguides 24 changes as the temperature changes. The change in index of refraction causes a shift in the wavelength of light signals traveling through the waveguide 24. The wavelength shift indicates the amount of change in the wavelength of light traveling through the light transmitting medium 16 per change in the temperature of the light transmitting medium 16 and is often expressed in terms of nm/° C. The wavelength shift for light transmitting media and optical components 12 is often measured for typical wavelengths of optical networks. For instance, wavelength shifts are often measured at about 1550 nm.

The light transmitting medium 16 by itself is associated with a wavelength shift. For instance, the wavelength shift of silica is about 0.01 nm/° C. while the wavelength shift for silicon is about 0.08 nm/° C. The wavelength shift of a light transmitting medium 16 is not the same as the wavelength shift of a waveguide 24 formed from the light transmitting medium 16. As noted above, strain applied to the waveguide 24 can change the index of refraction of the waveguide 24. For instance, changes in temperature can cause the base 18 to apply a strain to the waveguide 24 that causes a change in the index of refraction of the waveguide 24. This change in the index of refraction results in a strain induced change to the wavelength shift of the light transmitting medium 16. As a result, the wavelength shift of a waveguide 24 results from a combination of the wavelength shift associated with the light transmitting medium from which the waveguide 24 is constructed and a strain induced wavelength shift.

In some instances, the wavelength shift of a waveguide 24 is not consistent along the length of the waveguide 24. As a result, the wavelength shift of a waveguide 24 can refer to the average wavelength shift along the length of the waveguide 24.

The wavelength shift for the optical component system 10 can be expressed as dλ/dT where λ, is the mode of the wavelengths of light signals processed by the optical component 12 and T is the temperature. Because an optical component system 10 having waveguides 24 with a reduced wavelength shift have a reduced temperature sensitivity, an optical component system 10 designed such that dλₒ/dT=0 has a reduced temperature sensitivity.

Equation 1 shows dλₒ/dT for the optical component shown in FIG. 2. In equation 1, dλₒ/dT is expressed as a function of nₑ and ΔL, where nₑ is the effective index of refraction of the waveguide and 6 is the strain tensor on the waveguide. Previous attempts to express dλₒ/dT as a function of nₑ and ΔL have not included the term including ∂(ΔL)/∂T. As a result, previous solutions of this equation were incomplete and did not provide accurate results. Without the correct solution to dλₒ/dT, the ability of a single layer warping member 14 to reduce the thermal sensitivity of optical components 12 is obscured.

$$\frac{ⅆ {λ}_{o}}{ⅆ T} = \frac{{λ}_{o}}{{n}_{e}} \frac{\partial {n}_{e}}{\partial T} + \frac{{λ}_{o}}{Δ L} \frac{\partial ( Δ L )}{\partial T} + ( \frac{{λ}_{o}}{{n}_{e}} \frac{\partial {n}_{e}}{\partial ϵ} + \frac{{λ}_{o}}{Δ L} \frac{( \partial Δ L )}{\partial ϵ} ) \frac{ⅆ ϵ}{ⅆ T} \qquad ( 1 )$$

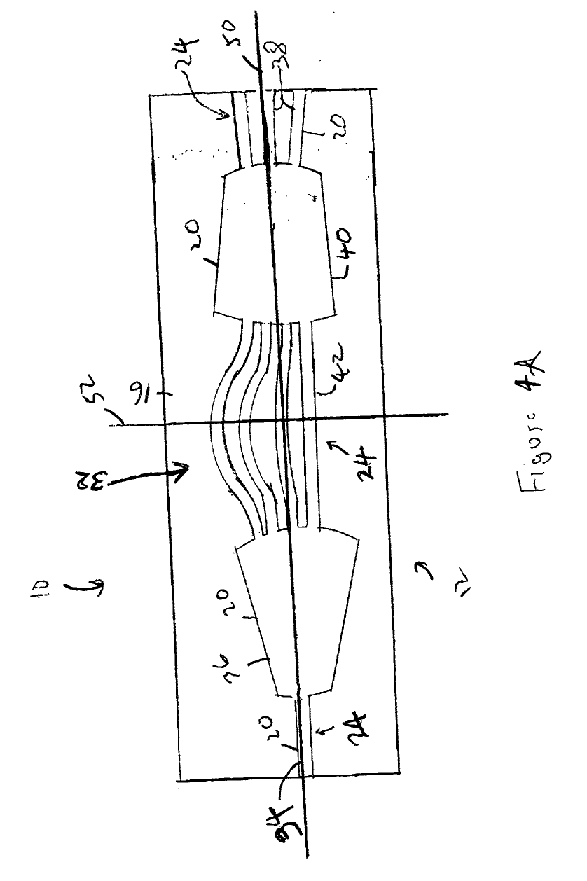

FIG. 3 illustrates Equation 1 solved for the strain applied to the waveguide 24 on the optical component 12 of FIG. 2 by a warping member 14 constructed from a layer of aluminum. The y axis illustrates the dimensionless strain on the waveguide 24 caused by the warping of the aluminum layer and the x axis illustrates the thickness of the aluminum layer. The illustrated solution is for a silicon light transmitting medium 16, a silica light barrier 26 and a silicon substrate 28. The ridge 20 of the waveguide 24 has a thickness of 10 μm, a height of 6 μm and a width of 7 μm. The light barrier 26 has a thickness of 0.4 μm and the substrate 28 has a thickness of 525 μpm. Accounting for the thickness of a cladding layer 30 and/or epoxy layer used to attach the warping member 14 has been shown not to substantially affect the solution. As a result, the solution does not account for a cladding layer 30 or an epoxy layer.

Table 1 illustrates the values of the material properties used to generate FIG. 3. It is acknowledged that different sources report a wide range of values for these properties and that the results may depend on the choice of property values.

The strain shown in FIG. 3 is a compressive strain in that the higher the strain the more compressed the waveguide 24. The compressive strain results from the difference in the coefficient of thermal expansion of the aluminum warping member 14 and the base 18. The magnitude of the strain that results from the warping of aluminum and the base is sufficient to overcome the effects of both temperature based changes to the waveguide index of refraction and strain based changes to the waveguide index of refraction. As a result, FIG. 3 illustrates that a warping member 14 constructed from a single layer can reduce the temperature sensitivity of an optical component 12. In practice, a warping member 14 constructed from a single layer can reduce the wavelength shift of the waveguides 24 by greater than 10%; by greater than 50%; by greater than 80% or by greater than 90% of the wavelength shift that occurs without the warping member 14 positioned adjacent to the base 18.

TABLE 1

| Material Property | Si | SiO₂ | Al (1060 Alloy) |
|---|---|---|---|
| Modulus (Gpa) | 187 | 76.5 | 69 |
| Poisson's ratio | .27 | .17 | .33 |
| CTE (10⁻⁶/° C.) | 2.6 | .5 | 24 |

FIG. 3 also indicates that in some instances, more than one thickness of aluminum layer can provide the desired amount of strain on the waveguide 24. In particular, an aluminum warping member 14 with a thickness of about 200-400 μm or 400-2000 μm can provide the desired amount of strain. A suitable thickness includes, but is not limited to, a range of 300-800 μm and a range of 300-500 μm.

As noted above, FIG. 3 shows the level of strain placed on a silicon waveguide. Prior research on the use of bi-metals to reduce the thermal sensitivity of optical components 12 has been centered on optical components 12 having silica waveguides 24 because silica is about eight times less sensitive to temperature changes than is silicon. It was believed that the increased temperature sensitivity of silicon made the use of a bimetal unlikely to provide satisfactory reduction in the temperature sensitivity of silicon waveguides 24. However, the solution to equation 1 illustrates that single layer members can be used to reduce the temperature sensitivity of optical components 12 having silicon waveguides 24 and other waveguides 24 constructed from light transmitting media associated with wavelength shift greater than the wavelength shift of silica. Because FIG. 3 shows this result is possible with a single layer warping member 14, similar results can likely be achieved with multiple layer warping member 14. As a result, the invention also relates to optical component systems 10 employing optical components 12 with waveguides 24 constructed from light transmitting media having a wavelength shift greater than 0.01 nm/° C., greater than 0.02 nm/° C., greater than 0.04 nm/° C., greater than 0.06 nm/° C. or greater than 0.08 nm/° C. In practice, the warping member 14 can reduce the wavelength shift of these waveguides 24 by greater than 10%; by greater than 50%; by greater than 80% or by greater than 90% of the wavelength shift of the waveguides 24 that occurs without the warping member 14 positioned adjacent to the base 18.

Other materials can be used as the warping member 14. Suitable materials include, but are not limited to, copper, polymers and epoxy. Suitable thickness for a warping member 14 constructed from copper include, but are not limited to, a range of 200-500 μm and a range of 200-320 μm. Suitable thicknesses for a warping member 14 constructed from an epoxy include, but are not limited to, a range of 200-2000 μm and a range of 600-1200 μm. Suitable thickness for a warping member 14 constructed from a polymer include, but are not limited to, a range of 200-2000 μm and a range of 800-2000. The thickness of a polymer can be more dependent on the modulus and CTE of the selected polymer than other materials. Suitable modulus for the polymer include, but are not limited to, 3-10 GPa.

Whether some materials can serve as the warping member 14 depends on the material used for the waveguide 24. For instance, the low coefficient of thermal expansion for silica means that optical components 12 having silica waveguides 24 are less sensitive to temperature than components having silicon waveguides 24. As a result, optical components 12 having silica waveguides 24 require a warping member 14 that provides a lower level of strain on the waveguides 24 than does an optical component 12 having silicon waveguides 24. Because stainless steel has a relatively low coefficient of thermal expansion, stainless steel may not be able to generate the levels of strain needed for use with silicon waveguides 24 but may be effective for use with silica waveguides 24.

Table 2 shows the dimensions for a plurality of optical components 12 and the associated warping members 14. For instance, Table 2 shows the thickness of a warping member 14 constructed from aluminum, copper and epoxy for an optical component having a substrate 28 thickness of 525 μm, a light barrier 26 thickness of 0.4 μm, ridge 20 thickness of 10 μm, a ridge 20 height of 6 μm and a ridge 20 width of 7 μm.

TABLE 2

| | | | | | Aluminum | Copper | Epoxy |
|---|---|---|---|---|---|---|---|
| | | | Light | | Warping | Warping | Warping |
| Ridge 20 | Ridge 20 | Ridge 20 | barrier 26 | Substrate 28 | member 14 | member 14 | member 14 |
| Thickness | Height | Width | Thickness | Thickness | Thickness | Thickness | Thickness |
| (μm) | (μm) | (μm) | (μm) | (μm) | (μm) | (μm) | (μm) |
| 10 | 6 | 7 | .4 | 525 | 400 | 3000 | 1000 |

Table 3 illustrates the values of the material properties used to generate FIG. 3. It is acknowledged that different sources report a wide range of values for these properties and that the results may depend on the choice of property values.

TABLE 3

| Material | | | | | |
|---|---|---|---|---|---|
| Property | Si | SiO₂ | Al (1060 Alloy) | Copper | Epoxy |
| Modulus (GPa) | 187 | 76.5 | 69 | 110 | 10 |
| Poisson's ratio | .27 | .17 | .33 | .37 | .3 |
| CTE | 2.6 | .5 | 24 | 24 | 60 |

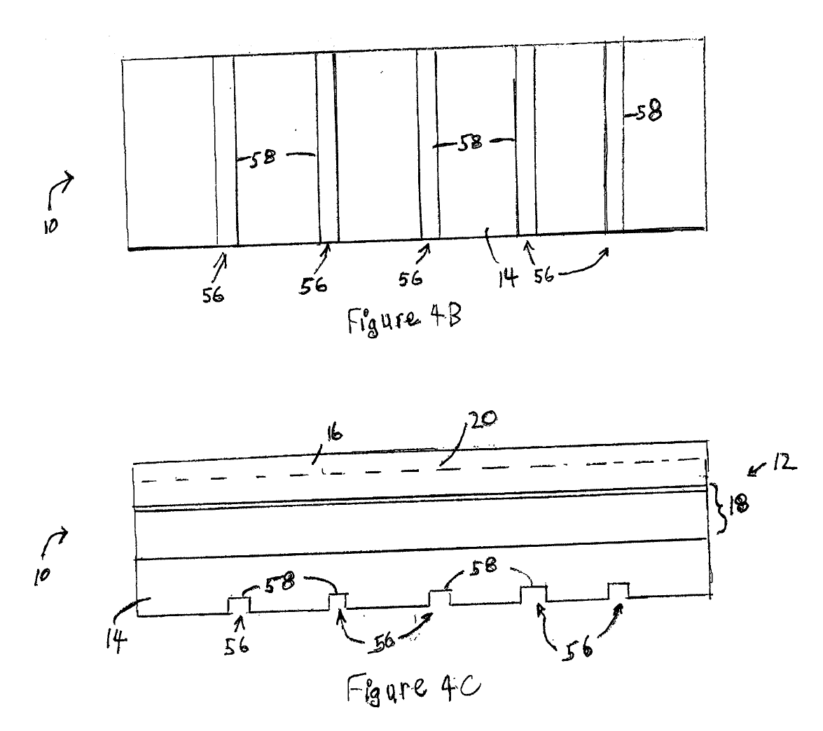

The optical components 12 for use with the warping member 14 are typically not symmetrical. For instance, FIG. 4A is a topview of an asymmetrical optical component 12. A first axis 50 and a second axis 52 are shown overlaid on the optical component 12. The first axis 50 and the second axis 52 are substantially parallel to a plane defined by the bottom of the substrate 28. The second axis 52 extends across the waveguides 24 when looking at a topview of the optical component 12.

During warping of the optical component 12, the ridges 20 of the waveguides 24, the input star coupler 36 and the output star coupler 40 provide asymmetrical resistance to bending of the optical component 12. For instance, a ridge 20 of a waveguide 24 effectively acts as an I-beam that resists bending along the longitudinal axis of the waveguide 24 but does not provide large resistance to bending along an axis perpendicular to the longitudinal axis of the waveguide 24. As a result, the optical component 12 is more flexible along the second axis 52 than along the first axis 50. Hence, when temperature changes cause warping of the optical component 12, the optical component 12 bends more along the second axis 52 than along the first axis 50. Accordingly, at most locations in the light transmitting medium 16, the amount of strain along the first axis 50 is different than the amount of strain along the second axis 52. This difference in strain causes light of different polarities light signals to travel through the waveguide 24 differently. Accordingly, the optical component 12 can cause multiple polarity light signals to separate in accordance with the different polarities.

As shown in FIG. 4B through FIG. 4C, the warping member 14 can include one or more regions of weakness 56 configured to reduce separation of a multi polarity light signal. FIG. 4B is a bottomview of a warping member 14 for use with the optical component 12 of FIG. 4A. FIG. 4C is a sideview an optical component system 10 including the warping member 14 of FIG. 4B bonded to the optical component 12 of FIG. 4A. The dashed line illustrates the base of the ridge 20 on the optical component 12. The regions of weakness 56 are arranged so as to bring the flexibility of the optical component system 10 along the first axis 50 closer to the flexibility along the second axis 52. For instance, each region of weakness 56 can include one or more grooves 58 that extend across the first axis 50. The grooves 58 cause the warping member 14 to be more flexible along the first axis 50 than along the second axis 52. When the warping member 14 is added to the optical component 12, the warping member 14 adds more resistance to bending along the second axis 52 than along the first axis 50. As a result, the flexibility of the optical component system 10 along the first axis 50 is closer to the flexibility of the optical component system 10 along the second axis 52 than is achieved by the optical component 12 alone.

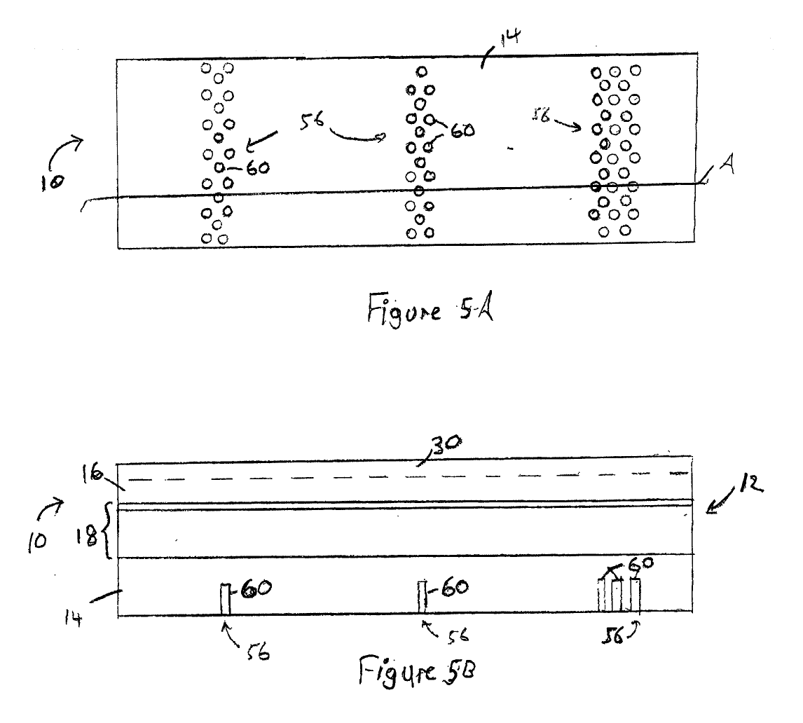

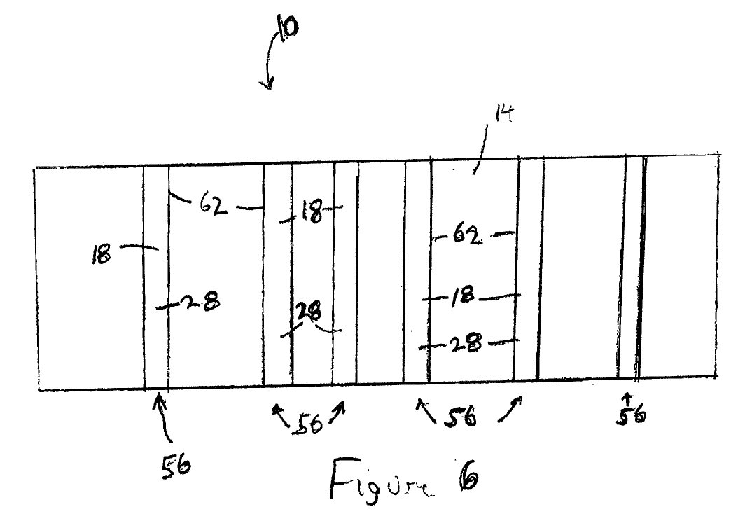

The one or more regions of weakness 56 need not include grooves 58. For instance, the one or more regions of weakness 56 can include holes 60 as shown in FIG. 5A and FIG. 5B. FIG. 5A is a bottom view of a warping member 14 and FIG. 5B is a cross section of the warping member 14 taken at the line labeled A. The holes 60 are grouped so as to form the regions of weakness 56.

The regions of weakness 56 can also be gaps 62 between sections of the warping member 14 as shown in FIG. 6. FIG. 6 is a bottomview of the optical component system 10. The regions of weakness 56 can include grooves 58 that extend across and through the warping member 14. In some instances, the warping member 14 can be constructed from a plurality of spaced apart sections. The gap 62 between the sections can serve as the region of weakness 56 in the warping member 14.

The regions of weakness 56 preferably extend across the least flexible axis of the optical component 12 when viewed from a topview of the optical component system 10. The least flexible axis is often not parallel to the sides of the optical component 12. As a result, the one or more regions of weakness 56 need not be positioned parallel to a side of the optical component 12. Further, the regions of weakness 56 need not extend across the least flexible axis of the optical component 12 in order to provide effective equalization of the strain along the first and second axis 52.

The regions of weakness 56 need not be evenly spaced. For instance, the density of the regions of weakness 56 can be higher under the star couplers of FIG. 4A than under the waveguides 24 in order to create a more uniform flexibility along the first axis 50. Additionally, each region of weakness 56 need not have the same dimensions. For instance, when the regions of weakness 56 include grooves 58, the grooves 58 under the star couplers of FIG. 4A can be wider than the grooves 58 under the waveguides 24 in order to provide a more uniform flexibility of the optical component system 10 along the first axis.

Although the regions of weakness 56 are shown as being parallel to one another, the regions of weakness 56 need not be parallel. For instance, the regions of weakness 56 can be angled relative to one another or can cross one another. Further, the regions of weakness 56 need not be parallel to the sides of the optical component 12 as shown above.

The one or more regions of weakness 56 need not be positioned on the warping member 14. For instance, the one or more regions of weakness 56 can be formed in the substrate 28 before the warping member 14 is attached to the optical component 12. The regions of weakness 56 can be formed in the top and/or bottom of the substrate 28 before the warping member 14 is attached to the optical component 12.

The one or more regions of weakness 56 can be formed before or after the warping member 14 is attached to the optical component 12. Suitable methods of forming the regions of weakness 56 in a substrate 28 and or in a warping member 14 include, but are not limited to, milling, drilling, etching and cutting including laser cutting and drilling. When the regions of weakness 56 are formed after the warping member 14 is attached to the optical component 12, the region of weakness 56 can extend through the warping member 14 and into the optical component 12. For instance, when the region of weakness 56 includes holes 60, the holes 60 can be formed through the warping member 14 into the substrate 28. When the regions of weakness 56 are formed by the gaps 62 between sections of the warping member 14, attaching the sections of the warping member 14 to the optical component 12 such that the sections of warping member 14 are spaced apart from one another can form the recesses.

Although the regions of weakness 56 are shown above as gas filled recesses, the regions of weakness 56 can be filled with other materials. For instance, the regions of weakness 56 can be filled with an elastic material such as a rubber. The elastic material can provide a smooth surface to the optical component system 10 while still increasing the flexibility of the optical component system 10.

The dimensions and layout of the one or more regions of weakness 56 must be experimentally fine tuned. These parameters can be determined by delivering a multipolarity light signal into a waveguide 24 on the optical component 12 and measuring the separation between the different polarities. The dimensions of the regions of weakness 56 can be changed to find where the separation approaches zero. For instance, when one or more regions of weakness 56 include a groove 58, the depth and width of the grooves 58 can be increased to find where the lowest separation in the polarities occurs. If the level of separation that can be achieved is not satisfactory another layout of the one or more regions of weakness 56 can be tried. For instance, the number of regions of weakness 56 can be changed or the regions of weakness 56 can be formed with a different orientation relative to the waveguides 24 on the optical component 12.

The addition of the one or more regions of weakness 56 to the warping member 14 may affect the thickness of the warping member 14 that is needed to reduce the effects of the temperature changes on the performance of the optical component 12. Equation 1 can be used to approximate the thickness of the warping member 14 that is suitable for use with the optical component 12; however, the optimized layout of the regions of weakness 56 may prevent the approximated thickness from providing the needed temperatures sensitivity reduction. As a result, the thickness of the warping member 14 that is needed to provide the desired reduction in the temperature sensitivity of the optical component 12 may also need to be experimentally determined. Hence, the optimal warping member 14 thickness and region of weakness 56 configuration for use with a particular optical component 12 may need to be experimentally determined.

Equation 1 is provided only to illustrate the ability of a warping member 14 having a single layer of material to reduce the temperature sensitivity of optical components 12 and to show that warping members 14 can be used to reduce the temperature sensitivity of optical components 12 having waveguides 24 constructed from light transmitting media with a wavelength shift greater than the wavelength shift of silica. As noted above, Equation 1 can also be solved to determine an approximate thickness for the warping member 14 that is to be used with an optical component 12. However, the thickness resulting from the solution of Equation 1 serves as an approximate thickness. Accordingly, in many cases, the optimal thickness of the warping member 14 will need to be experimentally determined. The approximate thickness yielded by Equation 1 can provide a guideline for the experimental determination of the optical warping member 14 thicknesses.

Once the optimal thickness of a warping member 14 is determined for a particular construction of an optical component 12, a warping member 14 having that thickness can generally be used in conjunction with all optical components 12 having that construction when the materials used in a single layer warping member 14 have such a high consistency.

Although the regions of weakness 56 are disclosed in the context of the warping member 14, warping members 14 according to the present invention need not include one or more regions of weakness 56. Further, in some instances, a strain equalization member that has regions of weakness 56 configured to equalize the strain along different axes of the optical component 12 can replace the warping member 14. The strain equalization member need not provide substantial warping of the optical component 12 or can provide warping of the optical component 12 that does not decrease the wavelength shift of the waveguides 24 on the optical component 12.

Although the optical component system is disclosed in the context of an optical component having a demultiplexer, the optical component system is not limited to optical systems that include demultiplexers. For instance, the optical component system can include optical components with amplifiers, dispersion compensators, filters, switches and other components.

Although the optical components disclosed in the context of reducing the temperature sensitivity of optical components, there are times when it is desirable to increase the temperature sensitivity of optical components. For instance, optical components having an enhanced temperature sensitivity may enhance the performance of the optical filter taught in U.S. patent application Ser. No. 09/845,685, filed on Apr. 30, 2001, entitled “Tunable Filter” and incorporated herein in its entirety and U.S. patent application Ser. No. 09/872,472, filed on Jun. 1, 2001, entitled “Tunable Optical Filter” and incorporated herein in its entirety. Optical components with enhanced temperature sensitivity can be generated by using equation 1 so as to select a warping member that will provide the desired level of enhanced temperature sensitivity.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. An optical component system, comprising:
an optical component having a light transmitting medium positioned over a base, one or more waveguides associated with a wavelength shift being defined in the light transmitting medium; and
a warping member positioned adjacent to the base, the warping member constructed from a single layer of material that acts in conjunction with the base to warp the optical component so as to reduce the wavelength shift of the one or more waveguides below the wavelength shift of the waveguides that occurs without the warping member being positioned adjacent to the base.

2. The system of claim 1, wherein the warping member acts in conjunction with the base to apply a compressive strain to the one or more waveguides.

3. The system of claim 1, wherein the warping member includes one or more regions of weakness configured to enhance flexibility of the warping member.

4. The system of claim 1, wherein the optical component is less flexible along a first axis than along a second axis that intersects the first axis, the warping member being more flexible along the first axis than along the second axis, the first axis and the second axis being parallel to a plane defined by a bottom of the base.

5. The system of claim 1, wherein the optical component is less flexible along a first axis than along a second axis that crosses the first axis and the warping member includes one or more regions of weakness that extend across the first axis when looking at a topview of the optical component system, the first axis and the second axis being parallel to a plane defined by a bottom of the base.

6. The system of claim 1, wherein the warping member includes one or more regions of weakness that extend across the one or more waveguides when looking at a topview of the optical component.

7. The system of claim 1, wherein the warping member is constructed from a layer of aluminum.

8. The system of claim 7, wherein the layer of aluminum has a thickness of 300-800 μm.

9. The system of claim 1, wherein the warping member is constructed from a layer of copper.

10. The system of claim 9, wherein the layer of copper has a thickness of 200-500 μm.

11. The system of claim 1, wherein the warping member is constructed from a layer of epoxy.

12. The system of claim 11, wherein the layer of epoxy has a thickness of 600-1200 μm.

13. The system of claim 1, wherein the warping member is constructed from a layer of polymer.

14. The system of claim 13, wherein the layer of polymer has a thickness of 800-2000 μm.

15. The system of claim 1, wherein the light transmitting medium is silicon.

16. The system of claim 1, wherein the light transmitting medium is silica.

17. The system of claim 1, wherein the warping member has a thickness of 200-2000 μm.

18. The system of claim 1, wherein the warping member serves to reduce the wavelength shift of the one or more waveguides by greater than 50% of the wavelength shift of the waveguides that occurs without the warping member positioned adjacent to the base.

19. The system of claim 1, wherein the optical component includes a demultiplexer.

20. An optical component system, comprising:
an optical component having one or more waveguides defined in a light transmitting medium positioned over a base, the one or more waveguides being associated with a wavelength shift and the light transmitting medium being associated with a wavelength shift of greater than 0.01 nm/° C.; and
a warping member positioned adjacent to the base, the warping member configured to warp the optical component so as to reduce the wavelength shift of the one or more waveguides below the wavelength shift of the waveguides that occurs without the warping member being positioned adjacent to the base.

21. The system of claim 20, wherein the light transmitting medium is associated with a wavelength shift of greater than 0.02 nm/° C.

22. The system of claim 20, wherein the light transmitting medium is associated with a wavelength shift of greater than 0.04 nm/° C.

23. The system of claim 20, wherein the light transmitting medium is associated with a wavelength shift of greater than 0.06 nm/° C.

24. The system of claim 20, wherein the light transmitting medium is silicon.

25. The system of claim 20, wherein the light transmitting medium is silica.

26. The system of claim 20, wherein the warping member acts in conjunction with the base to apply a compressive strain to the one or more waveguides.

27. The system of claim 20, wherein the warping member serves to reduce a wavelength shift of the one or more waveguides by greater than 50% of the wavelength shift of the waveguides that occurs without the warping member positioned adjacent to the base.

28. The system of claim 20, wherein the warping member includes one or more regions of weakness configured to enhance flexibility of the warping member.

29. The system of claim 20, wherein the optical component is less flexible along a first axis than along a second axis that intersects the first axis, the warping member being more flexible along the first axis than along the second axis, the first axis and the second axis being parallel to a plane defined by a bottom of the base.

30. The system of claim 20, wherein the optical component is less flexible along a first axis than along a second axis that crosses the first axis and the warping member includes one or more regions of weakness that extend across the first axis when looking at a topview of the optical component system, the first axis and the second axis being parallel to a plane defined by a bottom of the base.

31. The system of claim 20, wherein the warping member includes one or more regions of weakness that extend across the one or more waveguides when looking at a topview of the optical component system.

32. The system of claim 20, wherein the warping member is constructed from a layer of aluminum.

33. The system of claim 32, wherein the warping member has a thickness of 300-800 μm.

34. An optical component system, comprising:
an optical component having one or more waveguides defined in a light transmitting medium positioned over a base, the component being more flexible along a first axis than along a second axis that crosses the first axis, the first axis and the second axis being parallel to a bottom of the base; and
a warping member positioned adjacent to the base and configured to warp the optical component, the warping member being more flexible along the second axis than along the first axis.

35. The system of claim 34, wherein the warping member includes one or more regions of weakness configured to enhance flexibility of the warping member along the second axis.

36. The system of claim 34, wherein the optical component includes one or more regions of weakness that extend across the first axis when looking at a topview of the optical component system.

37. The system of claim 34, wherein the warping member includes one or more regions of weakness that extend across at least one of the one or more waveguides when looking at a topview of the optical component system.

38. The system of claim 34, wherein the warping member serves to reduce the wavelength shift of the one or more waveguides by greater than 50% of the wavelength shift of the waveguides that occurs without the warping member positioned adjacent to the base.

39. The system of claim 34, wherein the warping member is constructed from a single layer.

40. The system of claim 34, wherein the warping member is constructed from a layer of aluminum.

41. The system of claim 34, wherein the warping member is constructed from a layer of epoxy.

42. The system of claim 34, wherein the warping member is constructed from a layer of polymer.

43. The system of claim 34, wherein the light transmitting medium is silicon.

44. The system of claim 34, wherein the light transmitting medium is silica.

45. An optical component system, comprising:
an optical component having one or more waveguides defined in a light transmitting medium positioned over a base, the base including one or more regions of weakness configured to enhance the flexibility of the optical component along a length of at least one of the waveguides; and
a warping member positioned adjacent to the base and configured to warp the optical component so as to reduce the wavelength shift of the one or more waveguides below the wavelength shift of the waveguides that occurs without the warping member being positioned adjacent to the base.

46. The system of claim 45, wherein the one or more regions of weakness cross at least one of the one or more waveguides when looking at a topview of the optical component system.

47. The system of claim 45, wherein the warping member serves to reduce the wavelength shift of the one or more waveguides by greater than 50% of the wavelength shift of the waveguides that occurs without the warping member positioned adjacent to the base.

48. The system of claim 45, wherein the warping member is constructed from a single layer.
